(19) United States
(12) Patent Application Publication
(10) Pub. No.: US 2004/0053685 A1
(43) Pub. Date: Mar. 18, 2004

(54) Gaming display with moveable indicator and methods of use

(75) Inventors: Jerald C. Seelig, Absecon, NJ (US); Lawrence M. Henshaw, Hammonton, NJ (US)

Correspondence Address: IAN F. BURNS & ASSOCIATES, 1575 DELUCCHI LANE, SUITE 222, RENO, NV, 89502, US

(73) Assignee: Atlantic City Coin & Slot Service Company, Inc., Pleasantville, NJ

(21) Appl. No.: 10/245,624

(22) Filed: Sep. 16, 2002

(51) Int. Cl. A63F 9/24; A63F 13/00; G06F 17/00; G06F 19/00

(52) U.S. Cl. 463/25

(57) ABSTRACT

A gaming apparatus having a gaming device configured to allow a player to place a wager and play a game and at least one prize display in communication with the gaming device. The prize display has at least one housing, a plurality of first and second symbols displayed on the housing, and a first and second indicator configured to indicate at least one first and second symbol, respectively. The first and second indicators are coupled to their corresponding positioning mechanisms configured to move each indicator relative to the housing to selectively position the corresponding indicator to indicate a symbol. The prize display further has at least one controller in communication with the gaming device and the positioning mechanisms. The controller is preferably configured to activate each positioning mechanism when a prize event occurs.

### CROSS REFERENCE TO RELATED APPLICATIONS

None

### FIELD OF THE INVENTION

The present invention relates to gaming devices and, more particularly, to a gaming device and having a moveable indicator that indicates a prize to a player.

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in the primary game. A bonus prize is generally defined as an additional prize that is awarded to the player when a predefined event occurs. An example of a bonus game can be found in U.S. Pat. No. 5,848,932 issued to Adams. One of the gaming devices described in this document has a primary game having three spinning game reels and a bonus game having a bonus display with one spinning wheel. The spinning wheel is divided into multiple sections, and each section has symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game.

Rotatable pointers are disclosed in Baerlocher et al. (U.S. Pat. No. 6,336,863) and in Kelly et al. (U.S. Pat. No. 5,584,763). Baerlocher et al. discloses a slot machine with a bonus award display. The bonus award display has a bonus wheel and a mechanical, movable pointer. Kelly et al. discloses a gaming apparatus with hands and a game that requires players to control the stopping point of the clock hands to win a prize.

One of the problems associated with the devices disclosed in these references is that the outcome of the bonus game is communicated to the player almost immediately. When a bonus game is triggered, a bonus award is selected, displayed, and awarded to the player. A player can see what the outcome of the game is immediately after the pointers have stopped moving. What has long been need is a device that utilizes intermediate steps between the occurrence of the bonus event and the awarding of the bonus prize to add an additional element of anticipation and excitement for the players. It is further desired that the intermediate steps involve an eye-catching display and invokes in players the feeling that the bonus prize is increasing.

In view of the foregoing, there is a need in the art for a gaming device that provides bonus prizes with a highly attractive and entertaining device for displaying bonus prizes, additional element of surprise and excitement, and bonus games that invoke in players the feeling that the bonus prize is increasing.

### SUMMARY

Advantages

The various embodiments of the present invention may, but do not necessarily, achieve one or more of the following advantages:

provide a highly attractive and entertaining device for displaying prizes;

the ability to attract more patrons to play a game;

the ability to encourage players to play longer on a gaming apparatus;

provide a plurality of moveable prize indicators;

utilize intermediate steps between the occurrence of the bonus event and the awarding of the bonus prize;

provide an additional element of anticipation and excitement for players; and the ability to invoke in players the feeling that the prize they may win is increasing.

These and other advantages may be realized by reference to the remaining portions of the specification, claims, and abstract.

Brief Description of Certain Aspects of the Invention

The present invention comprises a gaming apparatus having a gaming device configured to allow a player to place a wager and play a game and at least one prize display in communication with the gaming device. The prize display has at least one housing, a plurality of first and second symbols displayed on the housing, and a first and second indicator configured to indicate at least one first and second symbol, respectively. The first and second indicators are coupled to their corresponding positioning mechanisms configured to move each indicator relative to the housing to selectively position the corresponding indicator to indicate a symbol. The prize display further has at least one controller in communication with the gaming device and the positioning mechanisms. The controller is preferably configured to activate each positioning mechanism when a prize event occurs.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The preferred embodiments are shown in the accompanying drawings wherein:

FIG. 1 is substantially a front view of a preferred embodiment of the gaming apparatus of the present invention.

FIG. 2 is substantially a detailed front view of the housing of the prize display of the gaming apparatus shown in FIG. 1.

FIG. 3 is substantially one embodiment of a positioning mechanism of the present invention.

FIG. 4 is substantially a partial cross-sectional view of the gaming apparatus of FIG. 1.

FIG. 5 is substantially a schematic diagram of a preferred gaming method of the present invention.

### DESCRIPTION OF THE PREFERRED EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

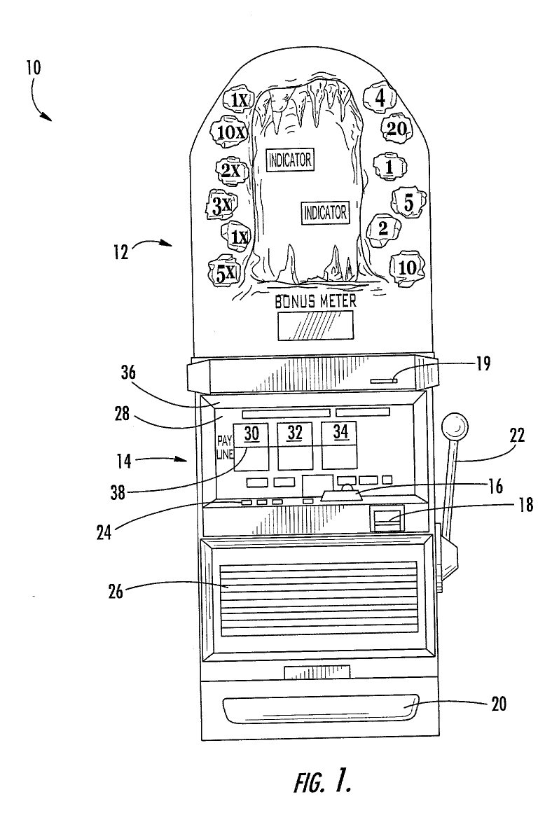

As seen in FIG. 1, the present invention comprises a gaming apparatus, generally indicated by reference number 10. In one preferred embodiment, gaming apparatus 10 comprises a prize display 12 and a gaming device 14. Gaming device 14 may be any of a large number of 10 devices that are adapted to allow players to play a game, such as gaming devices typically found in arcade and casino environments, including arcade games, video games, gambling machines, video poker machines, slot machines, etc. In the most preferred embodiment, gaming device 14 is further adapted to allow a player to place a wager and play a game, such as a slot machine.

Gaming device 14 may include a wager acceptor for accepting wagers, such as a coin slot 16, card reader 18, or a voucher reader 19. In addition, a payout mechanism (not shown) and a coin receptacle 20 may be provided for awarding prizes or for dispensing wagers to players cashing out and retiring from a game. A printer may also be provided for printing out cashless vouchers. A handle 22 and a button 24 may be provided for activating gaming device 14 to begin a game. A pay table 26 may further be provided to allow a player to see what symbol or combination of symbols provide a winning event. In at least one preferred embodiment, gaming device 14 may be an S Plus model gaming device manufactured by International Game Technology in Reno, Nev.

Gaming device 14 may further include a gaming outcome display 28 preferably positioned so that a player (not shown) playing gaming device 14 can see the display 28. Game outcome display 28 may utilize physical game reels 30, 32, and 34. Game reels 30, 32, and 34 may be attached to a drive mechanism (not shown) of gaming device 14 to rotate the reels in a manner well known in the art. Each game reel 30, 32, and 34 preferably has a plurality of symbols (not shown) positioned on the circumference of each game reel 30, 32, and 34. Game reels 30, 32, and 34 may be positioned side-by-side with coincident axes of rotation and a portion of their individual circumferences facing outward from gaming device 14.

A panel 36 preferably covers game reels 30, 32, and 34 such that only a portion of their individual circumferences is shown to the player. At least one symbol from any of game reels 30, 32, and 34 may be used to display a game outcome. At least one pay line 38 may be provided for the player to use in determining a game outcome based on the symbol or a combination of symbols positioned thereon. In an alternative embodiment, gaming outcome display 28 utilizes a video display (not shown) displaying images of game reels and images of at least one pay line. A video display may also display game symbols in many other formats and arrangements, such as playing cards.

Gaming apparatus 10 further has a prize display 12 configured to display at least one game and prize to a player. Prize display 12 is most preferably configured to display a bonus game and at least one bonus prize to the player. In other embodiments, prize display 12 may provide a primary game. Alternatively, prize display 12 may be a stand-alone device allowing a player to place a wager and play a game.

In the preferred embodiment, prize display 12 is attached to gaming device 14 and positioned on top of gaming device 14. In other embodiments (not shown), prize display 12 may be separate from gaming device 14 but in communication with gaming device 14. In this embodiment, prize display 12 may be in communication with a plurality of different gaming devices 14 via a computer network in a manner that is well know in the art. Prize display 12 may be positioned adjacent to or remote from gaming device 14. In other embodiments, prize display 12 is a stand-alone display not in communication with gaming device 14 and it may be capable of independently accepting wagers and awarding prizes to a player.

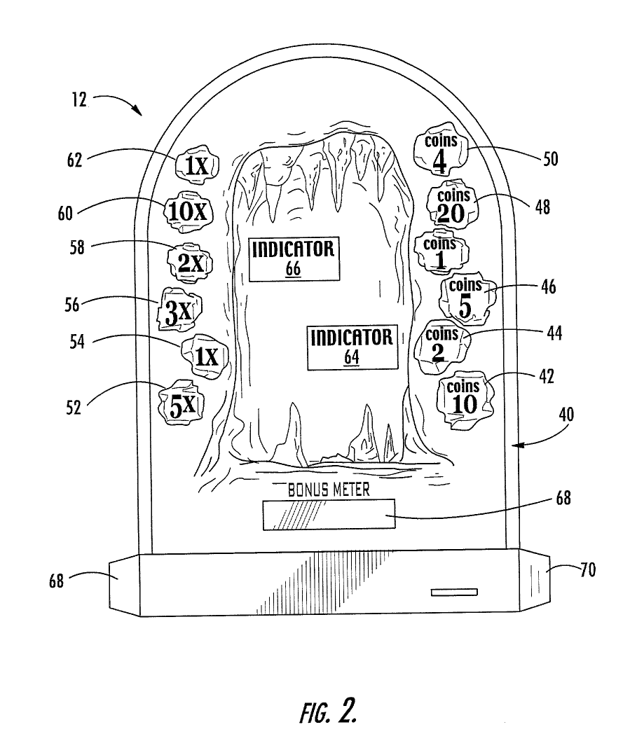

Referring now to FIG. 2, in the preferred embodiment, prize display 12 has a housing 40. Housing 40 may be arc-shaped and comprises a plurality of walls defining an internal space or cavity. Of course, housing 40 may be made in many different shapes. A plurality of symbols of first type 42, 44, 46, 48, and 50 may be displayed on one side of the front wall of housing 40. Each symbol of first type 42, 44, 46, 48, and 50 preferably represents a prize amount and most preferably a bonus prize amount, such as 1 coin, 5 coins, 20 coins, etc. A plurality of symbols of second type 52, 54, 56, 58, 60, and 62 may be displayed on another side of the front wall of housing 40. Each symbols of second type 52, 54, 56, 58, 60, and 62 preferably represents a multiplier, such as I×, 2×, 3×, etc. Of course, arrangement of symbols and representation of symbols may be varied and still fall within the scope of the invention. Symbols of first and second type are preferably painted or drawn on housing 40; however, they may also be attached, mounted, or engraved on housing 40 by methods known in the art. Symbols of first and second type may further include lights, blinking lights, or other devices that add attraction to the symbols.

In an alternative embodiment, the symbols are displayed using a changeable display device, such as a light emitting diode display (LED), a fiber optic display, or an incandescent light display. In this embodiment, a controller is in communication with the display device and the controller is configured to cause the display device to display selected symbols. This embodiment allows prize display 12 to change the symbols during or in between games.

In the preferred embodiment, at least two moveable indicators 64 and 66 are provided on the front wall of housing 40. Of course, the number and placement of the moveable indicators may vary. Moveable indicators 64 and 66 are preferably configured to move linearly in a substantially vertical orientation. In other embodiments (not shown), moveably indicators 64 and 66 may be configured to move horizontally or in a non-linear way. Moveable indicators 64 and 66 may be further configured to stop adjacent to their corresponding symbols. That is, first moveable indicator 64 is preferably configured to stop adjacent to at least one symbol of first type 42, 44, 46, 48, or 50 to indicate a prize amount. Second moveably indicator 66 is preferably configured to stop adjacent to at least one symbol of second type 52, 54, 56, 58, 60, or 62 to indicate a multiplier, which may be used to multiply a prize amount.

Moveable indicators 64 and 66 may be further configured to move adjacent to a bonus meter 68 displayed on the front wall of housing 40 to indicate to players that prize amount and/or multiplier will be used in determining players' total prize. Bonus meter 68 may be a changeable display device, such as a light emitting diode display (LED), a fiber optic display, or an incandescent light display. Moveable indicators 64 and 66 are preferably three-dimensional and designed with animation according to a theme. For example, in a mining theme, moveable indicators 64 and 66 may be three-dimensional ore carts with a miner positioned in the cart. Each time the carts stop at the symbols described above, gold nuggets may be “loaded” into the carts by causing display devices attached to the carts to display the gold nuggets. When the cart is stopped at a starting position, the gold nuggets may be offloaded and the value of the symbol may be displayed on meter 68.

Additionally, a variety of graphics and lights preferably designed according to a particular theme may be displayed on prize display 12. For example, with a mining theme, the front wall of housing 40 may be decorated with caves and treasures emphasized by blinking lights. Speakers 68 and 70 may further be provided to make an announcement or to play music preferably during a prize-winning event. Speakers 68 and 70 may be configured to announce a prize a player has won, announce features of the game offered by gaming apparatus 10, or play music to attract and entertain patrons.

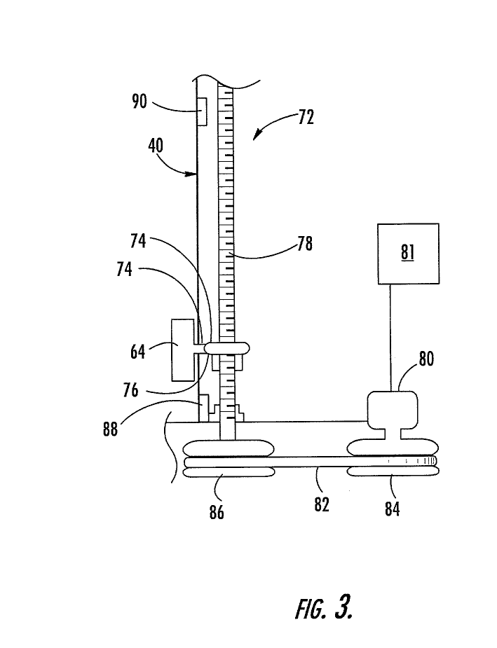

Referring now to FIG. 3, first moveable indicator 64 is preferably coupled to a first positioning mechanism 72 located within the confines of housing 40. Second moveable indicator 66 (not shown in FIG. 3) is preferably coupled to a second positioning mechanism (not shown in FIG. 3). First and second positioning mechanisms are preferably similar devices. First moveable indicator 64 is preferably coupled to a first positioning mechanism 72 by a bracket 74. A slot 76 in the front wall of housing 40 may be provided, which allows bracket 74 to pass through the front wall. Positioning mechanism 72 preferably comprises a worm gear 78 rotatable by a motor 80. Motor 80 and worm gear 78 may be attached via a drive belt 82, which rotates around a first wheel 84 attached to motor 80 and a second wheel 86 attached to worm gear 78. Positioning mechanism 72 may communicate with a controller 81, which preferably stores information regarding predetermined positions of various symbols displayed on the front wall of housing 40. Sensors 88 and 90, in communication with controller 81, may be provided to allow the controller to detect the position of the indicator. Other devices may be used to detect the position of the indicator, such as optical readers and the like.

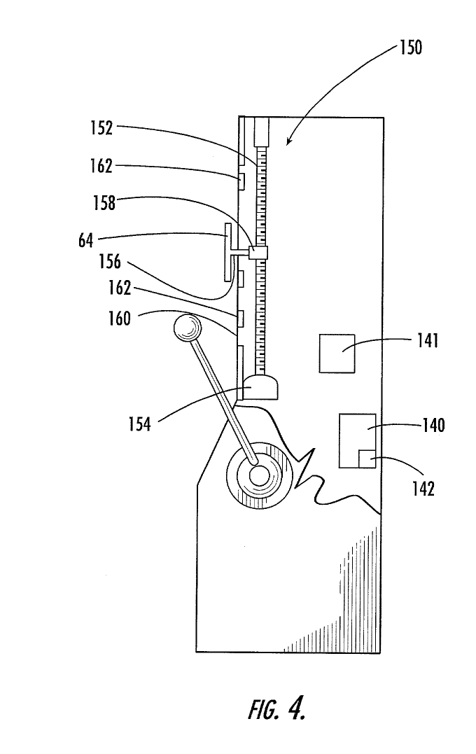

Referring now to FIG. 4, another embodiment of a positioning mechanism is shown. Positioning mechanism 150 may be a vertically positioned worm gear 152 that is caused to rotate by a motor 154. Indicator 64 may be attached to worm gear 152 by a bracket 156 that is attached to a nut 158 threaded on worm gear 152. A slot 160 may be provided in the front wall of prize display 12, which allows bracket 156 to pass through the wall. Sensors 162 may be provided to allow controller 140, or other control mechanism (not shown), to detect the position of indicator 64. While indicator 64 was shown to move vertically, it may also be moved horizontally, or diagonally or in a non-linear fashion, such as in rotating manner or zigzag manner.

In another embodiment, a wheel (not shown) may be attached to motor 154. Periphery of wheel has at least one notch detectable by a sensor (not shown) and used by the bonus game controller 141 or game controller 140 to monitor the position of moveable indicator 64. Wheel and worm gear 152 may be rotated together by motor 154. The sensor monitors the position of moveable indicator 64 by detecting the notch. Bonus game controller 141 or game controller 140 may further store information pertaining to a predetermined number of times the sensor has detected the notch and the corresponding predetermined position of moveable indicator 64. An optical interrupt (not shown) may be provided to reset the indicator position information. The sensor may be an infrared source and detector. In alternative embodiments, the periphery of wheel may comprise portions with different reflective characteristics, such as absorbent paint lines. Motors 80 and 154 may be a stepper motor, a solenoid, an actuator, or other motors known in the art.

With continued reference to FIG. 4, an electronic controller 140 that utilizes a random number generator 142 preferably controls gaming device 14. Random number generator 142 produces a random or pseudo random number for each game. The outcome of the game may be determined by comparing the random number to a table of outcomes stored in a memory and accessed by controller 140. A number of different tables of outcomes may be used and different tables may be used for different games. The tables can be designed so that different prizes have different probabilities of being awarded. Such design techniques are well known in gaming and are described above. Examples of such designs are shown in U.S. Pat. No. 4,448,419, issued to Telnaes, and U.S. Pat. No. 5,456,465, issued to Durham, which are hereby incorporated by reference. Controller 140 causes gaming outcome display 28 (FIG. 1), e.g., game reels 30, 32, and 34 to show the outcome of the game that corresponds to the outcome of random number generator 142. It is recognized that gaming device 14 may operate in many other ways and still achieve the objects of the present invention.

Gaming device 14 may also be capable, via controller 140 or other control mechanism (not shown), of producing a bonus-activating event. This event may be many different types of events. For example, a bonus-activating event may comprise a game outcome such as displaying a particular symbol, e.g., a “bonus” symbol, or combination of symbols, such as three “7”symbols on reels 30, 32, and 34. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result. Sensors may be provided external to gaming device 14 (not shown) to detect external bonus-activating events.

Bonus game controller (not shown) may further be provided to detect when a bonus activating event occurs in gaming device 14. This may be accomplished by gaming device controller 140 transmitting a signal to the bonus game controller that a bonus event has occurred. For example, gaming device controller 140 may determine the outcome of each game, and when a bonus-activating outcome occurs, it transmits a signal to the bonus game controller. Alternatively, the bonus game controller may periodically interrogate gaming device controller 140.

The bonus prize may be determined by a random number generator (not shown) and a virtual pay table as described in U.S. Pat. No. 5,823,874, issued to Adams, which is hereby incorporated by reference. A simple pay table may appear as follows:

TABLE 1

| Random Number | Amount Paid |
|---|---|
| 0.00 to 0.50 | $10.00 |
| 0.51 to 0.75 | $50.00 |
| 0.76 to 0.95 | X2 |
| 0.96 to 1.00 | $10,000.00 |

For example, if random number generator produced 0.65, controller may cause first indicator 64 to stop at symbol 42 representing 10 coins. Controller may further cause second indicator 66 to stop at symbol 52 representing a multiplier of 5. Controller may display “10×5=50” on bonus meter 68, and $50.00 would be awarded to the player.

The bonus selection process may be repeated to accumulate several bonus prizes that are added to form the award to the game player. The bonus selection process can be repeated a predetermined number of times. For example, the bonus game could be repeated three times to accumulate an award. The present invention is not limited to the example pay table shown. Furthermore, different kinds of bonus prizes, besides monetary prizes, may be awarded. For example, the bonus prizes may be goods, services, or additional games. Other effects may also be presented, such as pre-recorded sound from speakers. If the actual bonus prize is money, the amount of the bonus prize may be added to the player's credit meter (not shown) or the bonus prize may be dispensed to coin receptacle 20.

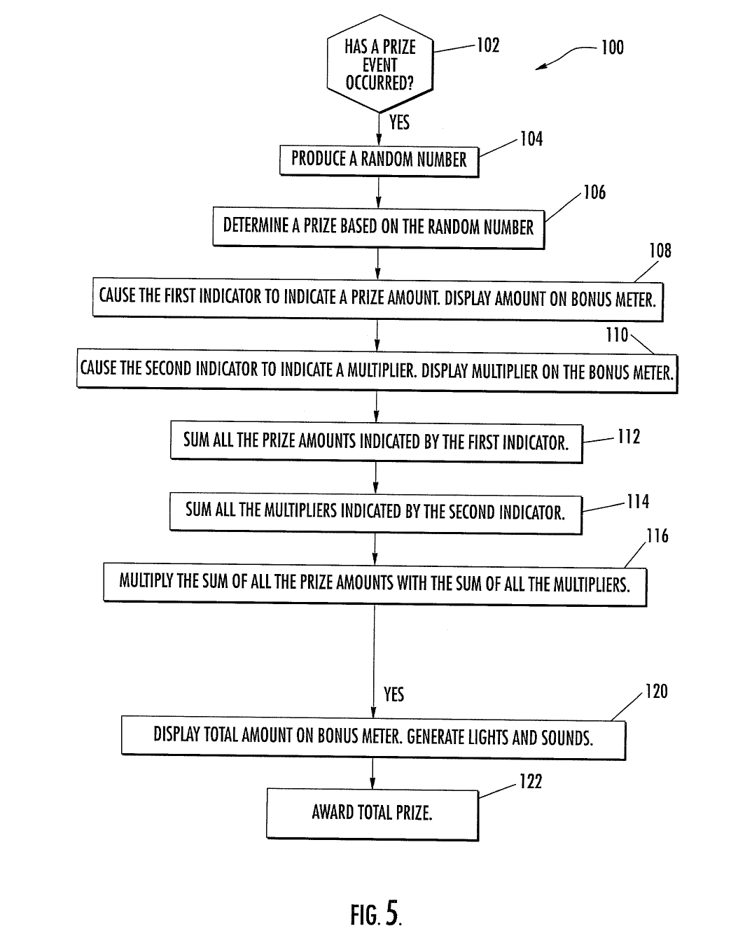

Referring now to FIG. 5, a preferred gaming method 100 is shown wherein a controller described above (not shown in FIG. 5) determines whether a prize event has occurred in step 102. If a prize event has occurred, controller produces a random number at step 104. At step 106, a prize based on the random number is determined. At step 108, the first indicator may move to a first symbol type to indicate a prize amount. The prize may then be displayed on the bonus meter. It is noted that step 108 may be repeated at a predetermined number of times and the sum of the prize values may be displayed to display the selected prize.

At step 110, the second indicator may move to a second symbol type to indicate a multiplier. The multiplier may also be displayed on the bonus meter. Step 108 may be repeated a predetermined number of times and the sum of the multiplier values may be displayed to display the selected multiplier. At step 112, the sum of prize amounts indicate by the first indicator may be calculated. At step 114, the sum of multipliers indicated by the second indicator may be calculated. At step 116, the sum of all the prize amounts from step 114 may be multiplied by the sum of all the multipliers from step 114. In step 120 the product of the sum of all of the prizes and the sum of all of the multipliers is displayed on the bonus meter. Lights and sounds may be generated to create a festive prize event atmosphere. At step 122, total prize may be awarded to the player. It is noted that the flowchart in FIG. 5 only shows one possible embodiment. Some of the steps in the flowchart may be varied, changed in order, or eliminated and still fall within the scope of the present invention.

### Conclusion

It can thus be realized that certain embodiments of the present invention provide a highly attractive and entertaining device for displaying prizes. Certain embodiments of the present invention further provide a moveable indicator to indicate a bonus prize. Thus, certain embodiments of the present invention can easily catch patrons' attention and invite patrons to play the game. Certain embodiments may further cause players to play longer because the display device enhances the anticipation, stimulation, and excitement experienced by players.

Other embodiments add intermediate steps between the occurrence of the bonus event and the awarding of the bonus prize to add additional element of anticipation, surprise, and excitement for the players. For example, an indicator may indicate another symbol representing another prize to be added to the player's total prize. An indicator may indicate another symbol representing a multiplier, which may be used to multiply the player's prize. Thus, the intermediate steps further involve an eye-catching display and invoke in players the feeling that the bonus prize is increasing.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A gaming apparatus, comprising:
(A) at least one game device, the game device being configured to allow a player to place a wager and play a game; and
(B) at least one prize display in communication with the primary game device, the prize display comprising:
(a) at least one housing;
(b) a plurality of first symbols displayed on the housing;
(c) a first indicator configured to indicate at least one of the first symbols;
(d) a first positioning mechanism coupled to the first indicator and the housing, the first positioning mechanism configured to move the first indicator relative to the housing to selectively position the first indicator to indicate at least one of the first symbols;
(e) a plurality of second symbols displayed on the housing;
(f) a second indicator configured to indicate at least one of the second symbols;
(g) a second positioning mechanism coupled to the second indicator and to the housing, the second positioning mechanism configured to move the second indicator relative to the housing to selectively position the second indicator to indicate at least one of the second symbols; and
(h) at least one controller in communication with the primary game device, the first positioning mechanism, and the second positioning mechanism, the controller being configured to activate the first positioning mechanism and the second positioning mechanism when a prize event occurs.

2. The gaming apparatus of claim 1, wherein the first symbols comprise at least one base symbol and the second symbols comprise at least one multiplier symbol.

3. The gaming apparatus of claim 2, wherein the first indicator may be positioned to indicate the base symbol and the second indicator may be positioned to indicate the multiplier symbol, wherein the player is awarded the product of the base symbol and the multiplier symbol after a prize event occurs.

4. The gaming apparatus of claim 1, further comprising a meter in communication with the controller, the controller being configured to cause the first indicator to indicate a plurality of the first symbols or at least one of the first symbols a plurality of times during a period of time and cause the meter to display the sum of the first symbols indicated by the first indicator during the period of time.

5. The game apparatus of claim 1, wherein the first positioning mechanism causes the first symbol to move in a substantially straight line.

6. The game apparatus of claim 5, wherein the straight line is substantially vertical.

7. The game apparatus of claim 5, wherein the first symbols are positioned adjacent to the straight line.

8. The gaming apparatus of claim 1, wherein the controller is configured to cause the first indicator to indicate a plurality of the first symbols or at least one of the first symbols a plurality of times during a period of time.

9. The gaming apparatus of claim 8, wherein the player is awarded the product of the sum of the first symbols indicated by the first indicator during the period of time and a second symbol indicated by the second indicator when a prize event occurs.

10. The gaming apparatus of claim 9, wherein the controller is configured to cause the second indicator to indicate a plurality of the first symbols or at least one of the first symbols a plurality of times during a period of time.

11. The gaming apparatus of claim 10, wherein the player is awarded the product of the sum of the first symbols indicated by the first indicator during the period of time and a sum of the second symbols indicated by the second indicator during a period of time when a prize event occurs.

12. A method of playing a game, comprising:
(A) allowing a player to place a wager;
(B) allowing a player to play a game;
(C) producing a prize event;
(D) positioning a first moveable indicator to indicate at least one of a plurality of displayed first symbols; and
(E) positioning a second moveable indicator to indicate at least one of a plurality of displayed second symbols.

13. The method of claim 12, further comprising awarding a prize to a player, the prize being the product of the first symbol indicated by the first moveable indicator and the second symbol indicated by the second moveable indicator.

14. The method of claim 12, further comprising:
(A) repeating step (D) in claim 12 a predetermined number of times;
(B) adding together each first symbol indicated by the first moveable indicator;
(C) awarding a prize to the player, the prize being the product of the sum of the first symbols indicated by the first moveable indicator and the second symbol indicated by the second moveable indicator.

15. The method of claim 12, further comprising:
(A) repeating step (D) in claim 12 a predetermined number of times;
(B) adding together each of the first symbols indicated by the first moveable indicator to obtain a first sum;
(C) repeating step (E) in claim 12 a predetermined number of times;
(D) adding together each of the second symbols indicated by the second moveable indicator to obtain a second sum;
(E) awarding a prize to the player, the prize being the product of the first sum and the second sum.

16. A gaming device, comprising:
(A) gaming means for allowing a player to place a wager and play a game;
(B) a plurality of first symbol means for communicating prize information to the player;
(C) means for indicating a plurality of first symbol means or at least one first symbol means a predetermined number of times.
(D) a plurality of second symbol means for communicating prize information to the player;
(E) means for indicating at least one of the second symbol means; and
(F) a second indicator means for indicating at least one of the multiplier symbol means.

17. The gaming device of claim 16, further comprising means for summing the first symbol means indicated a predetermined number of times.

18. The gaming device of claim 17, further comprising means for awarding a prize to the player, wherein the prize is the product of the sum of the first symbol means indicated a predetermined number of times and the second symbol means

19. The gaming apparatus of claim 18, wherein the means for indicating the at least one of the second symbol means comprises repeatedly indicating one or more second symbol means a predetermined number of times, further comprising means for summing the second symbol means indicated a predetermined number of times and means for awarding a prize to the player, wherein the prize is the product of the sum of the first symbol means indicated a predetermined number of times and the sum of the second symbol means indicated a predetermined number of times.

20. The gaming device of claim 17, further comprising means for displaying the sum of the first symbol means indicated a predetermined number of times.

21. The game apparatus of claim 1, wherein the first positioning mechanism causes the first symbol to move in a zigzag line.

22. The game apparatus of claim 5, wherein the straight line is substantially horizontal.

23. The game apparatus of claim 5, wherein the straight line is substantially diagonal.
